(19) United States
(12) Patent Application Publication
(10) Pub. No.: US 2010/0198457 A1
(43) Pub. Date: Aug. 5, 2010

(54) SYSTEM AND METHOD FOR ADAPTIVE MOUNTING AN ASSEMBLY

(75) Inventors: Waldemar Hermann, Jossgrund (DE); Joerg Ditzel, Freigericht (DE); Holger Ries, Schluechtern (DE)

Correspondence Address: MOORE & VAN ALLEN PLLC, P.O. BOX 13706, Research Triangle Park, NC, 27709, US

(73) Assignee: WOCO AVS GmbH, Bad Soden-Salmuenster (DE)

(21) Appl. No.: 11/993,623

(22) PCT Filed: Jun. 23, 2006
(86) PCT No.: PCT/EP06/06101

§ 371 Date: Mar. 25, 2010

(30) Foreign Application Priority Data
Jun. 23, 2005 (DE) 10 2005 029 234.8

(51) Int. Cl. G06F 17/00; F16F 15/02

(52) U.S. Cl. 701/36; 267/140.15

(57) ABSTRACT

A system for mounting an assembly, such as a motor vehicle engine, on a supporting structure such as a vehicle body. Disposed between the assembly and the supporting structure is a soft mount and/or a soft rubber spring featuring a damping and/or spring excursion along which the soft mount damps and/or adapts the load acting on the assembly. Also, disposed between the supporting structure and the assembly is an actuator which communicates an adaptive reaction force. A displacement of the assembly caused by the load along the damping or spring excursion of the soft mount or of the rubber spring can be cancelled out by a counter motion of the assembly prompted by the actuator.

The invention relates to a system for mounting an assembly, such as a motor vehicle engine.

Motor vehicle engines are usually mounted by hydraulic or pneumatic means or conventional rubber springs for supporting the engine on the vehicle body. To isolate engine noise and vibration from the vehicle body over practically the total acoustical frequency range it is known to soft mount the engine. Such soft mounts have, however, the drawback that because of the relatively high damping and/or spring excursion the mount needs to be allowed freedom of movement with amplitudes of up to 10 centimeters, becoming all the more, the softer the mount. The limited space available for mounting the engine thus permits the use of soft springs only to a limited extent.

With motor vehicle engines, the higher the power the higher the torque loading which because of soft engine mounting results in a linear displacement of the engine horizontally and/or vertically. Such movements of the engine relative to the vehicle body are detrimental to smooth vehicle handling due to the continual shift in the center of gravity of the vehicle. They also restrict the freedom in designing the architecture of the engine compartment due to the need to leave room to accommdate the dynamic response of the engine in each case. In view of the restricted space available in the engine compartment there is a need to minimize this accommodation of engine response so that the engine compartment offers enough room for additional parts of the vehicle.

To reduce the displacements due to dynamic response it is known to tune assembly mounts relatively stiff. But here the drawback is that this is detrimental to isolating the noise and vibration load at the cost of good noise, vibration and harshness (NVH) performance.

The object of the invention is to overcome the drawbacks of prior art by creating particularly a system for mounting an assembly such as a motor vehicle engine which now achieves stiff, low-excursion mounting of the engine whilst ensuring sufficiently good isolation of noise and vibration of the supporting structure from the assembly.

This object is achieved by the features of claim 1 by which a system for mounting the assembly particularly along a damping or adaptive response distance, an actuator being disposed between the supporting structure and the assembly capable of communicating a force to compensate the load force acting on the assembly for damping and/or adapting the response so as to actuate the assembly relative to the supporting structure preferably in a substantially fixedly adaptive position to tweak and/or maintain the damping and/or adaptive response distance due to the soft mount at least partly, preferably totally.

The adaptive force can be tweaked to prevent the load forces as anticipated or actually occuring. This aspect in accordance with the invention now makes it possible to completely do away with conventional mounts, such as rubber springs, hydraulic or pneumatic mounts for engine mounting or to use extremely soft mounts. With the aid of the actuator the response of the engine at least to soft mounting can now be adapted without having to sacrifice isolating noise and vibration transmission between the assembly and the supporting structure. Now, providing freedom of movement in the environment of the assembly can be minimized or even completely eliminated, as desired.

The actuator disposed between the assembly and the vehicle body comprises a live link to the soft mount to communicate load forces between the especially rigid actuator and the soft mount by providing the travel along which the live link is shiftable to compensate the damping and/or adaptive response distance at least in part. Furthermore the actuator has a fixed link to either the vehicle body or the assembly.

The actuator is operated as a function of the load, for example the compressive stress or strain of the soft mount such that the live link tweaks substantially the compliance of the soft mount so that the excursion thereof as allowed for by the soft mount is adapted at least in part, preferably practically completely. For example when compressively stressed the soft mount is compressed and the live link of the actuator is displaced away from the assembly or vehicle body. In accordance with the invention the actuator actuates the live link away from the fixed link in thus lengthening the travel of the actuator so that the adaptive response distance of the soft mount is compensated, at least in part, by the lengthened travel of the actuator, whereas under strain the live link is actuated nearer to the vehicle body or assembly.

In this case the actuator shortens its travel to compensate the strained adaptive response distance of the soft mount.

In one aspect of the invention the actuator is designed to actuate the assembly to an adaptive position and/or to maintain it in a substantially fixedly adaptive position relative to the supporting structure. A fixed adaptive position is understood to be when the assembly remains substantially consistently distanced from the supporting structure. In this arrangement the adaptive response distance along which the assembly can be moved by the actuator relative to the supporting structure can be limited to less than 2 cm, preferably less than 1 cm, preferably less than 0.5 cm, preferably less than 0.3 or 0.2 cm. The adaptive response distance or permissible amplitude in the movement of the mount mounting the assembly now achieves a significant reduction in the freedom of movement needed to accommodate movement of the assembly within the engine compartment.

The actuator transmits the compliance of the soft mount by the fixed link as a reaction force to the assembly or vehicle body in adapting the damping and/or spring excursion permitted by the soft mount at least in part, particularly fully, so that the assembly is maintained practically constantly distanced from the vehicle body.

Especially in adapting the damping excursion of the soft mount mounting the assembly the actuator may be configured as a linear actuator capable of actuating the assembly relative to the supporting structure and reciprocating the live link of the soft mount as a function of the compliance or damping excursion. The torque induced by the assembly results in linear movement of the assembly relative to the vehicle body, for example, in conventional rubber element mounting. In this arrangement the actuator can be configured as a reciprocating actuator lifting and lowering the assembly.

The linear actuator can be extended and retracted along a travel including the distance of the spring and/or damping excursion distance of the soft mount. The forces loading the assembly causing the soft mount to comply and thus displacement of the assembly result in a counteracting or reaction force being built up by the actuator. This force prompts additionally a movement counteracting actuating which compensates the compliance of the soft mount at least in part. In accordance with the invention particularly a pneumatic, hydraulic, electrically and/or mechanically actuator may be provided for building up a counteracting force and for counter-action.

In another aspect in accordance with the invention the mounting system is provided with an assembly positioner. In this arrangement the assembly positioner can be defined so that the assembly is maintained in a substantially fixed adaptive position relative to the supporting structure, particularly with a limited amplitude of movement to attain a predefined optimum adaptive position of 2 cm, preferably less than 1 cm, preferably less than 0.5 cm, preferably less than 0.3 or 0.2 cm. The assembly positioner may comprise a distance sensor such as a Hall sensor which senses the position of the assembly relative to the supporting structure particularly continually and converts it into an actual distance signal which is supplied to a comparator which compares the signal to a reference distance signal in generating a control signal which is supplied to the actuator from actuating the assembly into an adaptive position and/or to maintain the assembly in a substantially fixed adaptive position relative to the supporting structure.

In this arrangement the assembly positioner may be connected to at least one operating parameter sensor, such as vehicle handling sensors, for example an ABS sensor or the like, and comprise an arithmetic unit which calculates by means of the operating parameter signals of the at least one operating parameter sensor an assembly load as anticipated or having just occured, on the basis of which the control positioning signal can be determined which can position the assembly by means of the actuator to an adaptive position, particularly in advance and/or communicate an adaptive force to the assembly. Provided preferably at the assembly is a load sensor, such as a strain gauge which determines the operating load acting on the assembly and communicates same to the positioner.

Preferably the assembly positioner features a memory for storing at least one reference position value, such as a engine starting position or stopping position, in accordance with which the actuator sets the assembly to a predefined adaptive position.

In another aspect of the invention a hydraulic or pneumatic mount and/or a rubber spring may be disposed between the assembly and the supporting structure, the actuator, particularly the assembly positioner thereof being tuned to the hydraulic or pneumatic mount and/or a rubber spring such that the assembly can be positioned to counter the damping and/or spring excursion of the hydraulic or pneumatic mount and/or a rubber spring, especially shortening or lengthening the actuator distance as a function of the compliance and/or damping of the mount. As an example, the actuator may be formed by an aneroid, vacuum or pressure cell. As an alternative the actuator may comprise a pneumatic or hydraulic working chamber fluidly communicating with a pressure generating means as may be connected particularly in closed and open loop control with the assembly positioner.

In yet another aspect of the invention the pressure generating means comprises a pump and a control element such as a proportioning valve or incremental valve inserted between the pump and the working chamber.

To ensure a fast response in activating the actuator the working chamber is biased by a coil spring. To create high operating reliability the travel of the actuator is limited. For this purpose, at least one stop, preferably a pair of stops may be provided.

The invention relates furthermore to a method of mounting an assembly, such as a motor vehicle engine on a supporting structure, such as a vehicle body damped and/or adapted. For damping and/or adapting a load force acting on the assembly an adaptive force tuned to the load force is communicated to the assembly in, in particular, actively positioning the assembly relative to the supporting structure along the adaptive travel distance by an actuator.

In one aspect of the method in accordance with the invention the adaptive force can be generated such that the excursions of the mount are cancelled out or adapted substantially completely, particularly in cancelling out a load oscillation so that in operation the assembly remains in a substantially fixed adaptive position relative to the supporting structure. The method can be defined to comply with the way in which the mounting system in accordance with the invention functions.

Further properties, advantages and features of the invention will now be detailled by way of a preferred embodiment of the invention with reference to the attached drawing, in which:

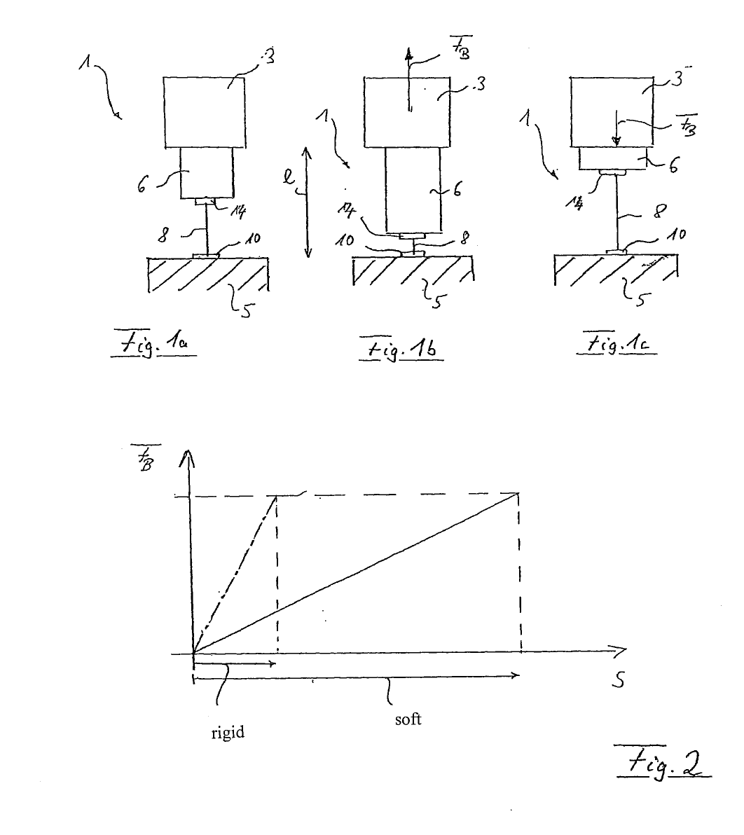

FIGS. 1a-1c are diagrammatically simplified views illustrating functioning of a system in accordance with the invention comprising a soft mount and an actuator in series, showing three different loading conditions;

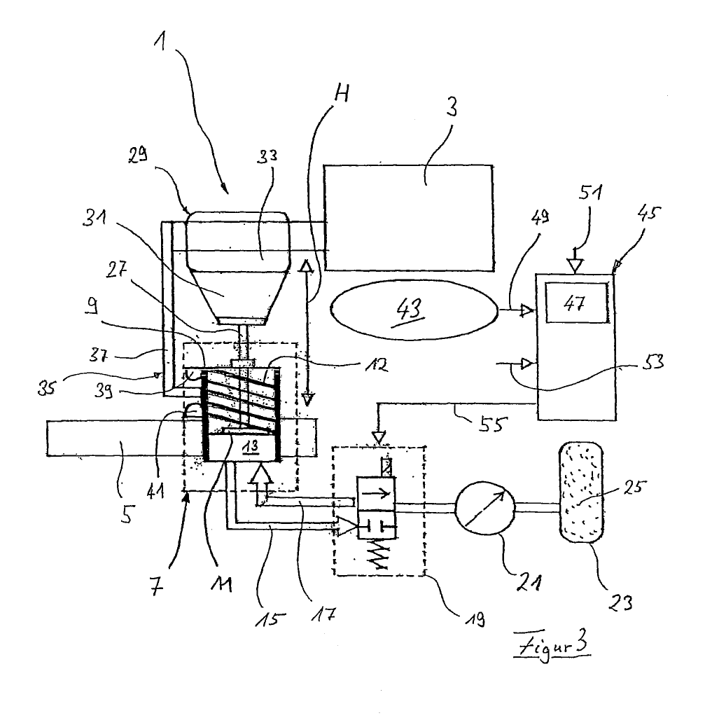

FIG. 2 is a force/excursion graph comparing in general a soft mount to a rigid mount;

FIG. 3 is a rough drawing of a system in accordance with the invention for damper mounting a motor vehicle engine.

Referring now to FIGS. 1a-1c there is illustrated the basic configuration of a mounting system 1 in three different operating situations, FIG. 1a showing the operating condition unloaded, FIG. 1b an operating condition with strain and FIG. 1c the operating condition under compressive stress.

The mounting system 1 in accordance with the invention is devised to mount a motor vehicle engine 3 relative to a vehicle body 5. Disposed between the motor vehicle engine 3 and the vehicle body 5 is a soft mount 6 in series with an actuator 8 in the form of a linear actuator. The actuator 8 has a fixed link 10 and a live link 14 at the soft mount 6. In the FIGS. 1a to 1c the fixed link 10 is defined by the vehicle body 5. It will be appreciated that it is just as possible to dispose the actuator 8 between the motor vehicle engine 3 and the soft mount 6, the fixed link 10 then being defined by the side of the motor vehicle engine 3 at the mount side.

In the no-load operating condition as shown in FIG. 1a the actuator 8 is positioned in a middle position, the soft mount 6 being vertically stressed.

As soon as load tension forces F_{B} occur which would tend to displace the motor vehicle engine 3 away from the vehicle body 5 the soft mount 6 is strained, as is shown in FIG. 1b. To prevent a relative motion between the vehicle body 5 and the motor vehicle engine 3 the actuator 8 is activated to shorten the effective travel 1 of the actuator between the fixed link 10 and the live link 14, resulting in the mounting distance 1 between the vehicle body 5 and the motor vehicle engine 3 remaining substantially constant as compared to the position as shown in FIG. 1a in thereby ensuring noise and vibration being isolated by the softness of the soft mount 6.

When the soft mount 6 is compressed by a load compression force F_{B}, as shown in FIG. 1c, the actuator 8 is activated such that the travel as compared to the normal position as shown in FIG. 1a is lengthened by the excursion of the soft mount under compression in thus likewise resulting in the distance between the vehicle body 5 and motor vehicle engine 3 remaining constant.

In other words, the actuator furnishes an adaptive but rigid connection between the fixed link 10 and the live link 14 in achieving noise and vibration isolation by the soft mount 6.

Referring now to FIG. 2 there is illustrated diagrammatically the response of a rigid mount as compared to a soft mount (not including the actuator in accordance with the invention). When subjected to a load F_{B} the force is communicated over short distances when the spring is rigid (see arrow “rigid”), whereas the distance is substantially longer, for the same load F_{B}, when the spring is soft (see arrow “soft”). Inserting an actuator in series with a soft spring in accordance with the invention to adapt the system to the conformance of the soft spring now makes it possible to employ very soft springs to isolate noise and vibration of the motor vehicle engine 3 from the vehicle body 5 without needing to make available additional freedom of movement to accommodate the major amplitudes in operation of the motor vehicle engine 3.

Referring now to FIG. 3 there is illustrated the system in accordance with the invention identifed by reference numeral 1 for mounting a motor vehicle engine 3.

The mounting system 1 in accordance with the invention supports the motor vehicle engine 3 on the vehicle body 5, it comprising therefor a reciprocating actuator with a piston/cylinder configuration 7. The cylinder 9 and the piston 11 define together a pneumatic work chamber 13 connected via a discharge line 15 and supply line 17 to a control element configured as a proportioning valve 19. The piston 11 is biased by a coil spring 12 so that the pneumatic work chamber 13 is pressurized for precise working of the reciprocating actuator in direct response to a load force. The proportioning valve 19 is fluidly connected to a pump 21 which is linked to a reservoir 23 housing a pneumatic work fluid 25.

The motor vehicle engine 3 is linked live to the piston 11, particularly to a piston rod 27 via an engine mount 29 formed by a series combination of a rubber spring 31 and a hydraulic mounting element 33 (not shown).

The damping mounting system 1 comprises in addition a mechanical adaptive limit 35 formed by an engaging arm 37 secured to the motor vehicle engine 3 as well as two stops, namely a MAX limit 39 and MIN limit 41 for engaging the engaging arm 37 in defining UP/DOWN motion of the motor vehicle engine 3.

The engine mount 29 as a combination of rubber spring 31 and hydraulic mounting element 33 is designed so soft that it serves particularly well to isolate noise and vibration of the motor vehicle engine 3 from the vehicle body 5 in furnishing a spring and/or damping excursion of approximately 8 cm to 10 cm.

The reciprocating actuator 7 is devised to adapt the assembly of motor vehicle engine 3 and engine mount 29 in the UP/DOWN direction H along a distance limited by the acting amplitude of the actuator as can be maximized by distance between MAX limit 39 and MIN limit 41. In accordance with the invention the reciprocating actuator is intended to build up forces to adapt the movement caused by the load forces so that the motor vehicle engine 3 can remain in a substantially fixedly adaptive position relative to the vehicle body 5. It has been discovered that even when setting a substantially fixedly adaptive position as wanted, minor adaptive movements of the motor vehicle engine 3 occur with amplitudes sensed down to less than 0.5 mm, depending on the accuracy of the actuator and positioner. For example, mechanical actuators such as high-accuracy worm actuators can provide a practically fixed adaptive position.

The mounting system 1 in accordance with the invention comprises furthermore an assembly positioner combining a Hall sensor 43 for sensing the level of the motor vehicle engine 3 relative to the vehicle body 5 with an arithmetic unit 45 connected to the Hall sensor 43. In addition or instead of the Hall sensor 43 a force sensor, for example a strain gauge may be affixed to the motor vehicle engine 3 to sense the load forces acting thereon, directly cancelled out by the reciprocating actuator so that there is no displacement of the motor vehicle engine 3 relative to the vehicle body. The arithmetic unit 45 comprises a comparator 47 which compares the actual travel signals 49 of the Hall sensor 43 to memorized reference values.

Continual adaptive control of the reference values is achieved by vehicle dynamic sensors signalling braking actions, periodic chassis actions, engine speed, accelerator positioning, etc. The arithmetic unit 45 may also receive an input of wanted reference values 53 defining a specific level setting of the motor vehicle engine 3 in an operating situation. For instance, when starting and stopping the engine, usually involving vibration of around 5 Hz with relatively large amplitudes, a reference value can prompt the proportioning valve 19 to position the motor vehicle engine 3 in such a limit that the engaging arm 37 is either at the MAX or MIN setting so that the vibrations on starting and stopping the engine are directly introduced itz vehicle body 5 where they are absorbed.

Adaptive operating of the mounting system in accordance with the invention will now be detailled:

From signals indicating engine and vehicle speed constituting the operating parameter 51 as input to the arithmetic unit indicative of a displacement of the engine anticipated or as tweaked, an optimized engine position is calculated in the arithmetic unit 45 for the operating situation involved along with the movement or force needed to adapt in achieving this engine position. In this arrangement the Hall sensor 43 watchdogs whether the motor vehicle engine 3 is in this position. If there is any difference between the reference position and the actual position, the arithmetic unit 45 calaculates the distance or force needed to adapt the change which is signalled to the reciprocating actuator 7 by a control signal 55 via the proportioning valve which is suitably devised to ensure instant attainment or maintaining the optimized position of the motor vehicle engine 3 as calculated.

The assembly positioner is also a permanent watchdog of the positions assumed by the assembly as materializing from motion thereof due to a change in engine power and adapting them by closed loop control. Particularly, compliance of an engine mount 29 is adapted by the reciprocating actuator in greatly restricting the maximum amplitude in the motion of the motor vehicle engine 3 within the engine compartment.

In accordance with the invention a mounting system is now provided which achieves the soft response for noise and vibration isolation in furnishing the wanted NVH performance, whereby the level control by means of the integrated reciprocating actuator minimizes the damping amplitude usually involved in the softness of the engine mount. It is to be noted that the mounting system in accordance with the invention can also be achieved without conventional engine mounts such as hydraulic or pneumatic mounts or a rubber element. It is particularly with pneumatic actuators that the necessary noise and vibration damping is achieved by the pneumatic actuator itself.

It is understood that the features of the invention as disclosed in the above description, in the drawings and as claimed may be essential to achieving the invention both by themselves or in any combination.

### LIST OF REFERENCE NUMERALS

1 system for mounting a motor vehicle engine

3 motor vehicle engine

5 vehicle body

6 soft mount

7 piston/cylinder configuration

8 actuator

9 cylinder

10 fixed link

11 piston

12 coil spring

13 pneumatic working chamber

14 live link

15 discharge line

17 feed line

19 proportioning valve

21 pump

23 reservoir

25 working fluid

27 piston rod

29 engine mount

31 rubber spring

33 mounting element

35 adaptive limiter

37 engagement arm

39 MAX limit

41 MIN limit

43 Hall sensor

45 arithmetic unit

47 comparator

49 actual distance signal

51 operating parameter

53 wanted reference value

55 control signal

F_{B} load forces

l effective mount spacing

1. A system for mounting an assembly, such as a motor vehicle engine, on a supporting structure such as a vehicle body, there being disposed between the assembly and the supporting structure a soft mount, such as a soft hydraulic or pneumatic mount and/or a soft rubber spring featuring a damping and/or spring excursion along which the soft mount damps and/or adapts the load acting on the assembly, there being additionally disposed between the supporting structure and the assembly an actuator which for adapting the system to the load communicates the assembly an adaptive reaction force, wherein a displacement of the assembly caused by the load along the damping or spring excursion of the hydraulic or pneumatic mount or of the rubber spring can be cancelled out by a counter motion of the assembly prompted by the actuator.

2. The system of claim 1, wherein the actuator is designed to actuate the assembly to an adaptive position and/or to maintain it in a substantially fixed adaptive position relative to the supporting structure.

3. The system of claim 1, wherein an adaptive response distance along which the assembly can be moved by the actuator relative to the supporting structure is defined less than 2 cm, preferably less than 1 cm, preferably less than 0.5 cm, preferably less than 0.3 or 0.2 cm.

4. The system of claim 1, wherein the actuator is a linear actuator.

5. The system of claim 1, wherein the actuator is configured as a reciprocating actuator devised to raise and/or lower the assembly.

6. The system of claim 1, wherein the actuator is operated pneumatically, hydraulically, mechanically and/or electrically.

7. The system of claim 1, wherein an assembly positioner is provided.

8. The system of claim 7, wherein the assembly positioner is defined so that the assembly is maintained in a substantially fixed adaptive position relative to the supporting structure, particularly with a limited amplitude of movement to attain a predefined optimum adaptive position of 2 cm, preferably less than 1 cm, preferably less than 0.5 cm, preferably less than 0.3 or 0.2 cm.

9. The system of claim 7, wherein the assembly positioner comprises a distance sensor such as a Hall sensor which senses the position of the assembly relative to the supporting structure and converts it into an actual distance signal which is supplied to a comparator which compares the actual distance signal to a reference distance signal in generating a control signal which is supplied to the actuator for actuating the assembly into an adaptive position and/or to maintain the assembly in a substantially fixed adaptive position relative to the supporting structure.

10. The system of claim 7, wherein the assembly positioner is connected to at least one operating parameter sensor, such as a vehicle handling sensor and comprises an arithmetic unit which calculates by means of the operating parameter signals of the at least one operating parameter sensor an assembly load as anticipated or having just occurred, on the basis of which a control signal can be determined which can set the assembly by means of the actuator to an adaptive position and/or communicate an adaptive force to the assembly.

11. The system of claim 7, wherein the assembly positioner features a memory for storing at least one reference position value, such as an engine starting position or stopping position, in accordance with which the actuator sets the assembly to a predefined special operating position which preferably differs from the adaptive position during normal operating of the assembly.

12. The system claim 7, wherein the actuator, particularly the assembly positioner thereof is tuned to the hydraulic or pneumatic mount and/or a rubber spring such that the assembly can be positioned to counter the damping and/or spring excursion of the hydraulic or pneumatic mount and/or a rubber spring, preferably that a damping and/or spring travel of the assembly along the damping and/or spring excursion caused by the hydraulic or pneumatic mount and/or a rubber spring is compensated such that the assembly remains in an adaptive position substantially fixed relative to the supporting structure.

13. The system of claim 1, wherein the actuator may be formed by an aneroid, vacuum or pressure cell.

14. The system of claim 1, wherein the actuator comprises a pneumatic or hydraulic piston/cylinder configuration including a pneumatic or hydraulic working chamber.

15. The system of claim 14, wherein the working chamber fluidly communicates with a pressure generating means connected particularly to the assembly positioner.

16. The system of claim 15, wherein the pressure generating means comprises a pump and a control element such as a proportioning valve or incremental valve inserted between the pump and the working chamber.

17. The system of claim 14, wherein the working chamber is biased by a spring.

18. The system of claim 17, wherein at least one stop, preferably a pair of stops is provided for additionally limiting an adaptive response distance of the actuator.

19. The system of claim 1, wherein the actuator rigidly links the soft mount and the supporting structure or assembly variably distanced, the actuator cancelling out compliance of the soft mount, such as damping and/or spring excursions at least in part, preferably practically completely so that despite compliance of the soft mount particularly the assembly is maintained substantially in a constant position relative to the supporting structure.

20. The system of claim 19, wherein in strain of the soft mount and thus a distancing of the assembly from the supporting structure as caused by the load, the actuator prompts a return counter positioning motion.

21. The system in of claim 19, wherein a compressive load would cause the soft mount to allow the assembly to approach the vehicle body, the actuator prompts an extending counter positioning motion.

22. A method for adaptive mounting an assembly, such as a motor vehicle engine, on a supporting structure such as a vehicle body, the assembly being damped and/or spring mounted on the supporting structure by a soft hydraulic or pneumatic mount and/or a soft rubber spring along a damping and/or spring excursion distance, wherein for adaptive response to a load acting on the mount, the assembly is communicated an adaptive force to displace the assembly relative to the supporting structure and that a displacement of the assembly caused by the load along the damping or spring excursion is cancelled out by a counter motion of the assembly prompted by the actuator.

23. The method of claim 22, wherein the adaptive force can be generated such that load force is cancelled out or adapted substantially completely, particularly in cancelling out a load oscillation so that in operation the assembly remains in a substantially fixed adaptive position relative to the supporting structure.

24. The method of claim 22, wherein a displacement of the assembly caused by the load along the damping or spring excursion of the hydraulic or aneumatic mount or of the rubber spring can be cancelled out by a counter motion of the assembly prompted by the actuator.
